(19) United States
(12) Patent Application Publication
(10) Pub. No.: US 2018/0335636 A1
(43) Pub. Date: Nov. 22, 2018

(54) Smartphone Screen Magnifier

(71) Applicant: Daniel Parncutt, Wilmington, DE (US)

(72) Inventor: Daniel Parncutt, Wilmington, DE (US)

(21) Appl. No.: 15/982,461

(22) Filed: May 17, 2018

Related U.S. Application Data
(60) Provisional application No. 62/507,323, filed on May 17, 2017.

(51) Int. Cl. G02B 27/02; G02B 1/14

(52) U.S. Cl. CPC G02B 27/027; G02B 1/14

(57) ABSTRACT

A magnifying screen protector is affixed to a touchscreen device with or without the use of a rugged case. The protector improves upon visual clarity of a screen of the touchscreen device. The protector improves upon the durability of the screen of the touchscreen device without degrading a user's experience.

This application claims priority to U.S. Provisional 62/507,323, filed May 17, 2017, which is hereby incorporated by reference as submitted in its entirety.

### FIELD OF THE INVENTION

The present invention relates to screen protectors, and, more particularly, screen protectors for smartphones and/or tablets with magnifying or text amplification capabilities.

### BACKGROUND

There is an estimated 2.32 billion smartphone users worldwide and by 2020 this number is expected to grow to 2.87 billion. Smartphones, with their PC-like intelligence, provide an all-in-one media experience by combining telecommunications (i.e. cell phone capabilities), media (i.e. music and/or video), web browsing, and messaging (i.e. iMessage, SMS, etc.). Original smartphones combined the capabilities of Personal Digital Assistants (PDAs) with cellular phones. The first smartphones had keyboards (i.e. BlackBerry®) and later versions ditched the keyboard and featured multi-touch screens with virtual keyboards (i.e. Apple iPhone® or Samsung Galaxy®). Smartphone screens typically provide high resolution graphics and measure 4.3″ to 5″ diagonally. Tablet screens typically measure 5″ to 10″ and beyond. Typical panel types include, but are not limited to, LCD, OLED, AMOLED, Super AMOLED, TFT, IPS, and TFT-LCD. Touchscreen displays are typically of two types, capacitive or resistive, with the former being used more frequently in today's smartphones. Capacitive touchscreens consist of a layer of glass coated with a transparent conductor (such as indium tin oxide). In response to being touched by a user's finger, an interruption is created in the screens electrostatic field (which is measurable as a change in capacitance) which is detected by phone's processor or chip and which in turn instructs phone's operating system to trigger an event or action accordingly. One major pitfall of a smartphone having a glass screen is its susceptibility to damage (i.e. cracked or shattered) after being dropped or bumped. Another problem is text legibility on a smartphone for the visually impaired. Far-sighted users may use reading glasses, or “cheaters”, for focusing on things up close. However, such glasses may be easily lost, misplaced, or broken, due to their lack of frequent use. Other types of visual aids, such as a magnifying glass or other handheld magnifying instrument can be difficult to maneuver or handle, especially in relation to a device's screen.

### BRIEF SUMMARY OF THE INVENTION

A screen protector having text amplification capabilities may be applied to a user device, such as a smartphone, tablet PC, or other such device having touchscreen capabilities.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 illustrates an embodiment of the conventional art;

FIG. 2 illustrates a front view of at least one embodiment of the disclosed invention;

FIG. 3 illustrates an exploded diagram in accordance with at least one embodiment of the disclosed invention;

FIG. 4 illustrates a top view of at least one embodiment of the disclosed invention;

FIG. 5 illustrates a front view of an alternate embodiment of the disclosed invention; and

FIG. 6A and FIG. 6B illustrate another alternate embodiment of the disclosed invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

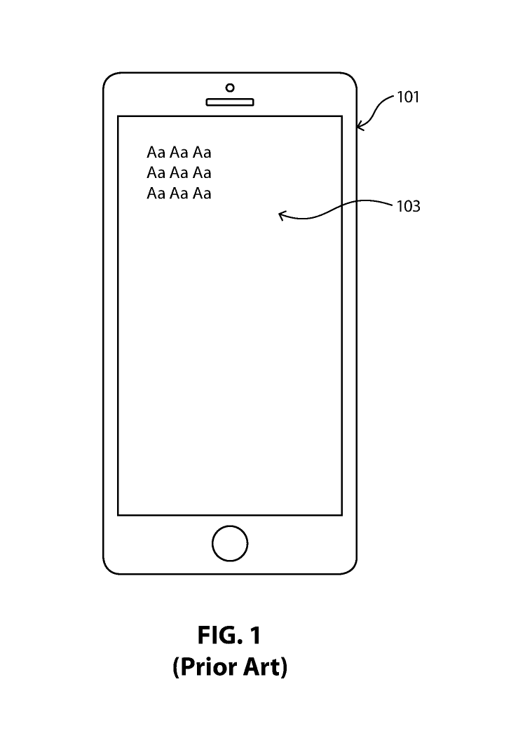

Referring to FIG. 1, shown is a device 101 as is known in the art. The device may be any type of mobile phone as is known in the art, such as an Apple iPhone® or a Samsung Galaxy® phone. Device 101 is meant to be exemplary and non-limiting. For example, device 101 may be a tablet computer (i.e. Apple iPad®) or an E-Reader (i.e. Amazon Kindle®), or any other type of screen having touch capabilities. Device 101 includes screen 103 displaying text or other media, such as videos, wherein the text may be, from the viewpoint of a user, difficult to read (i.e. out of focus) without some type of visual aid.

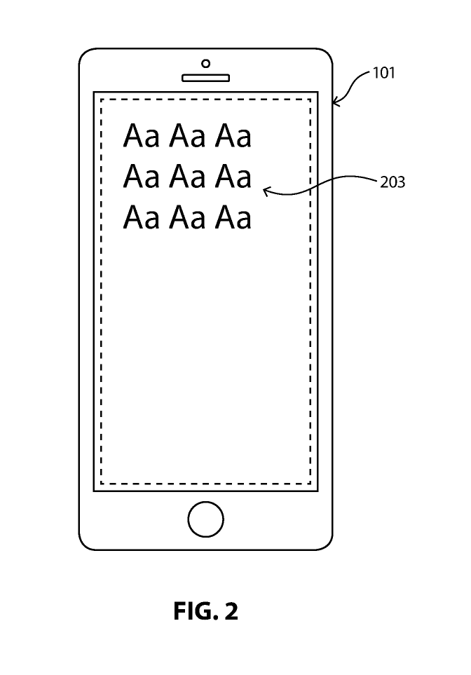

Referring now to FIG. 2, there is shown a device 101 with a screen protector 203 installed. Screen protector 203, having magnifying properties, provides a visual aid to a user, such as a far-sighted individual. Protector 203 may be comprised of magnifying elements and be composed of multiple layers. A top layer may provide protection for a device's screen. On a flat screen display, the protector, when viewed from different angles, may provide different magnifying properties. For example, when the top layer is a curved piece, such as a curved piece of plastic or other transparent materials, magnifying power may range between 2× and 5×. The screen protector may be composed of a single sheet or a nano-printed screen elements. Further, the screen may be composed of highly conductive materials with consideration given to touchscreen responsiveness so as not to degrade a user's experience.

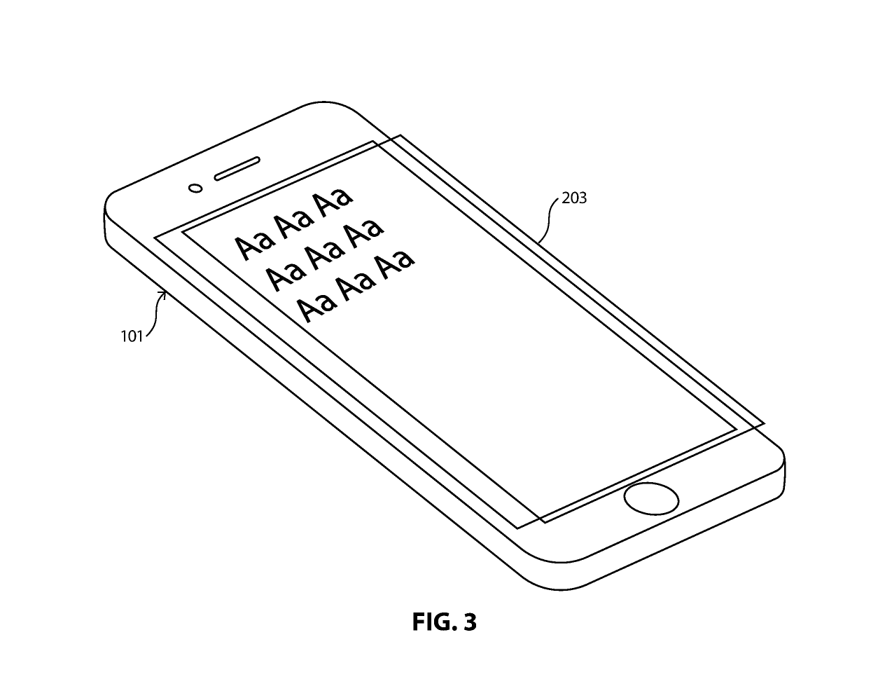

Referring now to FIG. 3, device 101 is shown with magnifying screen protector 203 in a detached state. A bottom layer of the screen protector may be comprised of adhesive materials for installation semi-permanently directly onto the device screen. In an alternative embodiment, the screen protector may be installed using static-cling technology.

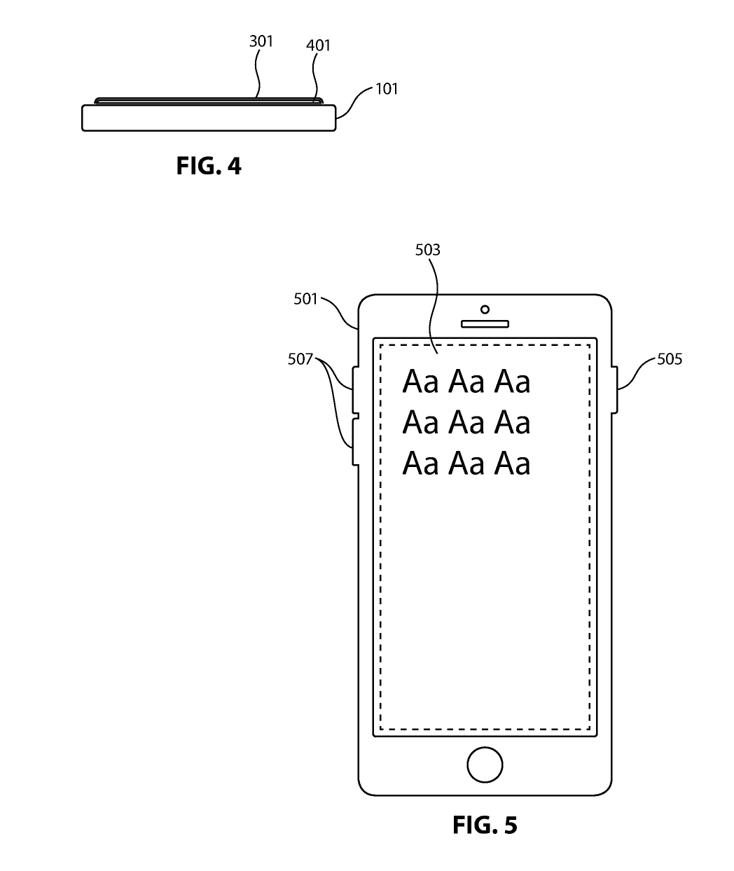

Referring now to FIG. 4, device 101 is shown with screen protector 301. In this embodiment, a backfill bubble lens 401 is utilized so as not to lose capacitive touch. Bubble lens 401 may be composed of highly conductive material so as not to lose any part of the device's touchscreen functionality. Further, lens 401 may comprise privacy glass elements.

Referring now to FIG. 5, there is shown an alternate embodiment of a screen protector 503 as being part of a snap-on device protector 501 that envelops a touchscreen device. The protector 501 would provide elements so as not to decrease functionality of the buttons of the device, such as on/off button 505 and volume rocker buttons 507.

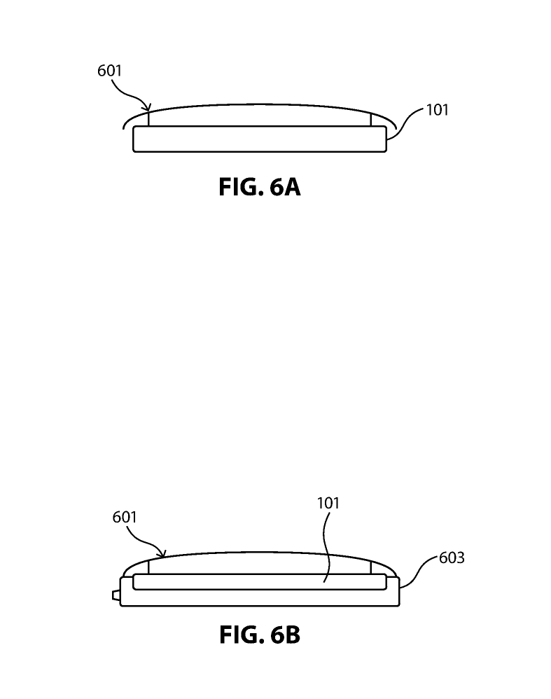

Referring now to FIGS. 6A and 6B, there is shown yet another alternative embodiment of a magnifying screen protector held in place by casing material. As shown in FIG. 6A, device 101 is shown having a screen protector 601 installed without a case for simplicity. In this embodiment, the magnifying screen protector viewing area would be larger than the device screen viewing area. For example, the viewing area of the screen protector may be around 10% larger. As shown, the protector may be rounded or curved around the device and provide magnification of a device's screen to provide an enlarged view of the screen. In this embodiment, the rounded portion may be the top layer of a screen protector. The protector may have a bottom layer placed flush against the device screen. Magnifying screen protector 601 may be equipped with technology to assist with capacitive touch so as not to lose touchscreen device functionality. Referring to FIG. 6B, device 101 is shown with magnifying screen protector 601 installed thereon using case 603. Case 603 may be composed of rugged materials to protect the device from damage from drops or falls. Rugged materials may be hard plastic, rubber, other like materials or a combination thereof. It is understood that the case shown is merely for exemplary purposes only and the case may take on different form factor proportions based on the device to be protected.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A screen protector, comprising:
a top layer;
a middle layer; and
a bottom layer.

2. The screen protector of claim 1, wherein the top layer comprises one or more anti-shatter film elements.

3. The screen protector of claim 1, wherein the middle layer comprises one or more magnifying elements.

4. The screen protector of claim 1, wherein the bottom layer comprises one or more adhesive elements.

5. The screen protector of claim 1, wherein the top, middle, and bottom layers are composed of transparent materials.

6. The screen protector of claim 1, wherein the top, middle, and bottom layers are affixed to a device semi-permanently via the bottom layer.
